(19) United States
(12) Patent Application Publication
(10) Pub. No.: US 2013/0185127 A1
(43) Pub. Date: Jul. 18, 2013

(54) Systems and Methods for Advertising

(71) Applicant: Martin Rödén, Taby (SE)

(72) Inventor: Martin Rödén, Taby (SE)

(21) Appl. No.: 13/352,190

(22) Filed: Jan. 17, 2012

(51) Int. Cl. G06Q 30/02

(52) U.S. Cl. 705/14.19

(57) ABSTRACT

A method for rendering content can comprise rendering a challenge, wherein the challenge is contextually related to the content, receiving a response to the challenge, comparing the received response to a comparator element, and providing a reward based upon the comparison of the received response and the comparator element.

### BACKGROUND

Advertisements over the Internet and other communication networks are common place. In the past, Internet based advertisements generally included graphical advertisements such as banner advertisements or text based advertisements located within a webpage.

Another form of internet based advertisement is sequential media, such as videos. These types of advertisements are similar to television commercials; however, the sequential media containing the advertisements are displayed in a portion of a webpage. One drawback to using sequential media is that sequential media is generally broadcast for a period of time generally lasting fifteen seconds to thirty seconds. During this time, it is very common for viewers to simply ignore the advertisement by viewing something else, such as another webpage, or turning the volume off. Therefore, it remains unclear whether the user is actually watching the advertisement or is simultaneously performing a different task, a task which dominates the attention of the user.

One way of increasing the likelihood that the user will pay attention to the sequential media is to target the user with sequential media that will be of interest to the user. As it is well known in the art, there is a variety of different ways to better target the user with an advertisement that will more likely interest the user. However, even if the user is successfully targeted, the advertisement may not effectively be transmitting the intended message. For example, the user may think that the commercial is selling one type of product when in actuality the commercial is selling another type of product.

Current advertisements over content and/or communication networks such as television and Internet do not provide a sufficient feedback to the advertisers regarding viewers.

### SUMMARY

It is to be understood that both the following general description and the following detailed description are exemplary and explanatory only and are not restrictive, as claimed. In an aspect, the systems and methods can comprise an arrangement for establishing and storing individually received information, such as answers in a memory or memory means, based upon one or more visually and/or orally presented challenges, such as in the form of question. As an example, the present systems and methods can be used to evaluate individual behaviors and/or opinions. As a further example, the systems and methods can be used to evaluate any time related differences and changing in opinions based the individual reactions when viewing a presented presentation or presentations. As yet a further example, the systems and methods can be used to evaluate individual opinions by evaluating given information based upon answers and/or behaviors and/or skills in different time related games or the like.

In an aspect, the present systems and methods can comprise an arrangement wherein information, such as answers to challenge questions can be received from a plurality of partaking/participating individuals, such as forming a selected group of individuals, and based upon one and the same visual presentation, presented on a display unit or a display screen.

In an aspect, the present systems and methods can comprise rendering a sequence of visual presentations, and one or more presented challenges, such as questions, related to one or more of said presentations, such as visually and/or orally presented question, wherein said question or questions are structured to directly or indirectly relate to said visual presentation or one or more sequent presented presentations.

In an aspect, a method can comprise rendering content, rendering a challenge, wherein the challenge is contextually related to the content, receiving a response to the challenge, comparing the received response to a comparator element, and providing a reward based upon the comparison of the received response and the comparator element.

In an aspect, a method can comprise rendering content to a plurality of users, rendering a challenge to the plurality of users, wherein the challenge is contextually related to the content, receiving one or more responses to the challenge, wherein each response comprises a time element defined by a time between the rendering of the challenge and the receipt of the respective response, comparing the received response to a comparator element to define one or more correct response, selecting one of the correct responses based upon a comparison of the respective time elements, and providing a reward to the user associated with the selected correct response.

In an aspect, a system can comprise a memory for storing challenge data, and a processor in communication with the memory, the processor configured to: transmit content; transmit a challenge based upon the challenge data, wherein the challenge is contextually related to the content; receive a response to the challenge; compare the received response to a comparator element; and provide a reward based upon the comparison of the received response and the comparator element.

In an aspect, a system can comprise a user interface, a processor in communication with the user interface, the processor configured to: render content through the user interface; render a challenge through the user interface, wherein the challenge is contextually related to the content; receive a response to the challenge; and render a reward based upon a comparison of the response to a comparator element.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a block diagram of an exemplary network;

FIG. 2 is a block diagram of an exemplary computing device;

FIG. 3 is a flow chart of an exemplary method;

FIG. 4A is a representation of a web page;

FIG. 4B is a representation of a mobile application;

FIG. 5 is a representation of a gallery;

FIG. 6 is a flow chart of an exemplary method; and

FIG. 7 is a representation of a scheduling application.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

As described in greater detail below, a network and/or system can be configured to provide an interactive advertisement to one or more users/viewers.

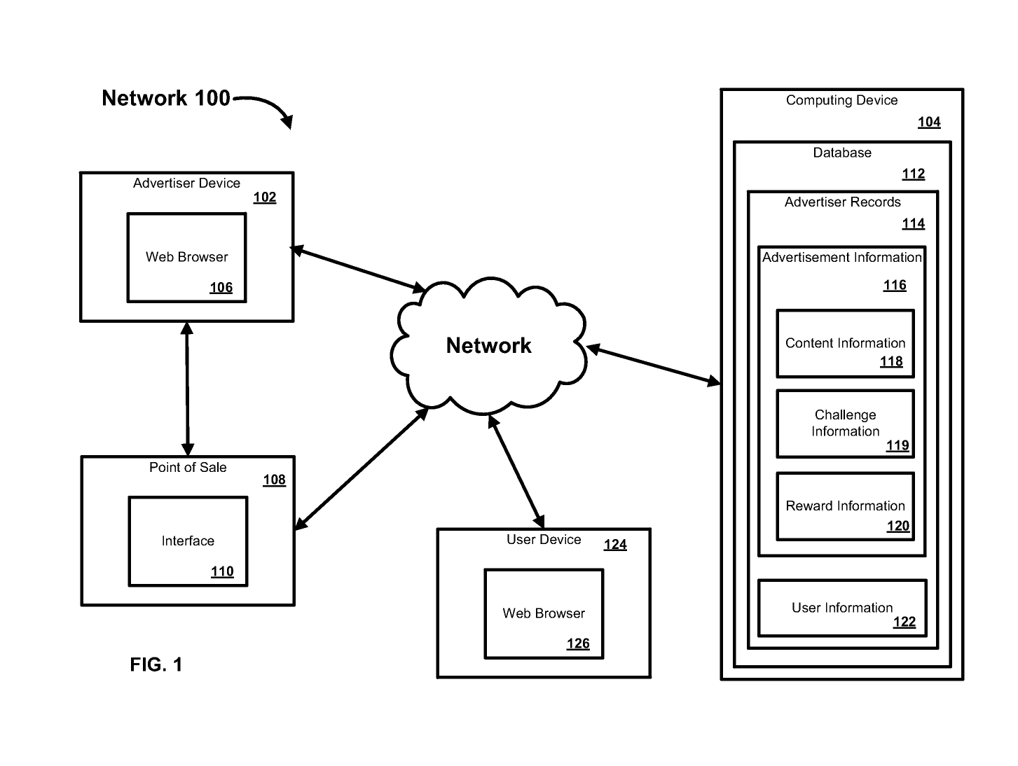

FIG. 1 illustrates various aspects of an exemplary network in which the present methods and systems can operate. The present disclosure relates to systems and methods for identifying a class of user. Those skilled in the art will appreciate that present methods may be used in systems that employ both digital and analog equipment. One skilled in the art will appreciate that provided herein is a functional description and that the respective functions can be performed by software, hardware, or a combination of software and hardware.

The network 100 can comprise an advertiser device 102 or merchant device in communication (e.g., directly and/or via a network) with a computing device 104 such as a server, for example. The computing device 104 can be disposed locally or remotely relative to the advertiser device 102. As an example, the advertiser device 102 and the computing device 104 can be in communication via a private or public network such as the Internet. Other forms of communications can be used such as wired and wireless telecommunication channels, for example.

In an aspect, the advertiser device 102 can be an electronic device such as a computer, a server, a smartphone, a laptop, a tablet, or other device capable of communicating with the computing device 104. As an example, the advertiser device 102 can comprise a web browser 106 for providing an interface to a user to interact with the advertiser device 102 and/or the computing device 104. The web browser 106 can be any interface for presenting information to the user and receiving a user feedback such as Internet Explorer, Mozilla Firefox, Google Chrome, Safari, or the like. Other software, hardware, and/or interfaces can be used to provide communication between the user and one or more of the advertiser device 102 and the computing device 104. As an example, the web browser 106 can request or query various files from a local source and/or a remote source. As a further example, the advertiser device 102 can be configured to transmit data to the computing device 104. Other devices and interfaces can be used to allow a user to intercommunicate with the computing device 104.

In an aspect, the seller device 102 can be configured to communicate (e.g., directly and/or via a network) with a point of sale 108. As an example, the point of sale 108 can be an electronic point of sale such as an e-commerce site, website, or software application for processing purchases. As a further example, the point of sale 108 can comprise hardware (e.g., terminal) and or software components for processing a transaction such as a purchase (e.g., including processing a prepaid card such as a gift card or debit card, redeeming virtual rewards, coupons, or credits, etc.). In an aspect, the seller device 102 can send/receive information to/from the point of sale 108 for configuring the point of sale 108 and/or retrieving information from the point of sale 108.

In an aspect, the point of sale 108 can comprise an interface 110 to allow a user to interact with the point of sale 108. As an example, the interface 110 can comprise a web application or interactive web page. As a further example, the interface 110 can render information to a user and receive user feedback. In an aspect, the point of sale 108 can be in communication with the computing device 104 to authenticate a user credential information provided through the interface 110. Other devices or systems can be used to authenticate a particular user information, login information, and/or credential information.

In an aspect, the computing device 104 can be a server for communicating with the advertiser device 102. As an example, the computing device 104 can manage the intercommunication between the advertiser device 102 and a database 112 for sending and receiving data therebetween. In an aspect, the database 112 can store a plurality of files (e.g. web pages). As an example, advertiser device 102 can request a file from the database 112. As a further example, advertiser device 102 can retrieve a file from the database 112.

In an aspect, the database 112 can store a plurality of advertiser records 114. As an example, one or more of the advertiser records 114 can comprise advertiser information 116 relating to a merchant, advertiser device 102, and/or the point of sale 108 of a particular merchant. In an aspect, the advertiser information 116 can comprise contact information, branding information, preferences, and mailing lists, for example. In an aspect, one or more of the advertiser records 114 can comprise content information 118 relating to a particular advertisement. As an example, one or more advertiser records 114 can comprise challenge information 119. As a further example, one or more advertiser records 114 can comprise reward information 120. Other information can be stored in the database 112 can/or associated with a particular advertiser record 114. As an example, the advertiser information 116 can comprise one or more of a URL for redirecting a user, a content name, a challenge name, a brand or slogan, a head line, an upload logotype, an upload overlay loop, and upload video, an upload overlay video, option information regarding content, challenger and/or reward rendering/delivery, sharing information, reward/coupon value, start date/time information, end date/time information, advertising campaign information, viewing information/limitations such as a max views by a single user, and the like.

In an aspect, the database 112 can store user information 122 relating to one or more users or intended viewers of content/advertisements. As an example, the user information 122 can comprise demographic information, contact information, user credentials, login credentials, a unique identifiers or passwords, and preferences. Other information can be stored in the database 112 can/or associated with a particular user information 122.

In an aspect, a user device 124 can be in communication with the computing device 104. The computing device 104 can be disposed locally or remotely relative to the user device 124. As an example, the user device 124 and the computing device 104 can be in communication via a private or public network such as the Internet. Other forms of communications can be used such as wired and wireless telecommunication channels, for example.

In an aspect, the user device 124 can be an electronic device such as a computer, a server, a smartphone, a laptop, a tablet, or other device capable of communicating with the computing device 104. As an example, the user device 124 can comprise a web browser 126 for providing an interface to a user to interact with the user device 124, the computing device 104, and or the point of sale 108. The web browser 126 can be any interface for presenting information to the user and receiving a user feedback such as Internet Explorer, Mozilla Firefox, Google Chrome, Safari, or the like. Other software, hardware, and/or interfaces can be used to provide communication between the user and one or more of the user device 124 and the computing device 104. As an example, the web browser 126 can request or query various files from a local source and/or a remote source. As a further example, the user device 124 can be configured to transmit data to the computing device 104. Other devices and interfaces can be used to allow a user to intercommunicate with the computing device 104.

In an aspect, a user can use the user device 124 to communicate with computing device 104 to transmit/receive data therebetween. As an example, the user device 124 can be configured to receive data from the computing device such as a promotion, advertisement, notification, or other communication. As a further example, the user device 124 can be configured to communicate with the point of sale 108 in order to allow the user to conduct a transactions such as a purchase or redeeming a coupon, reward, or credit. Other devices can be used to facilitate communication between a user and the computing device 104 and/or point of sale 108.

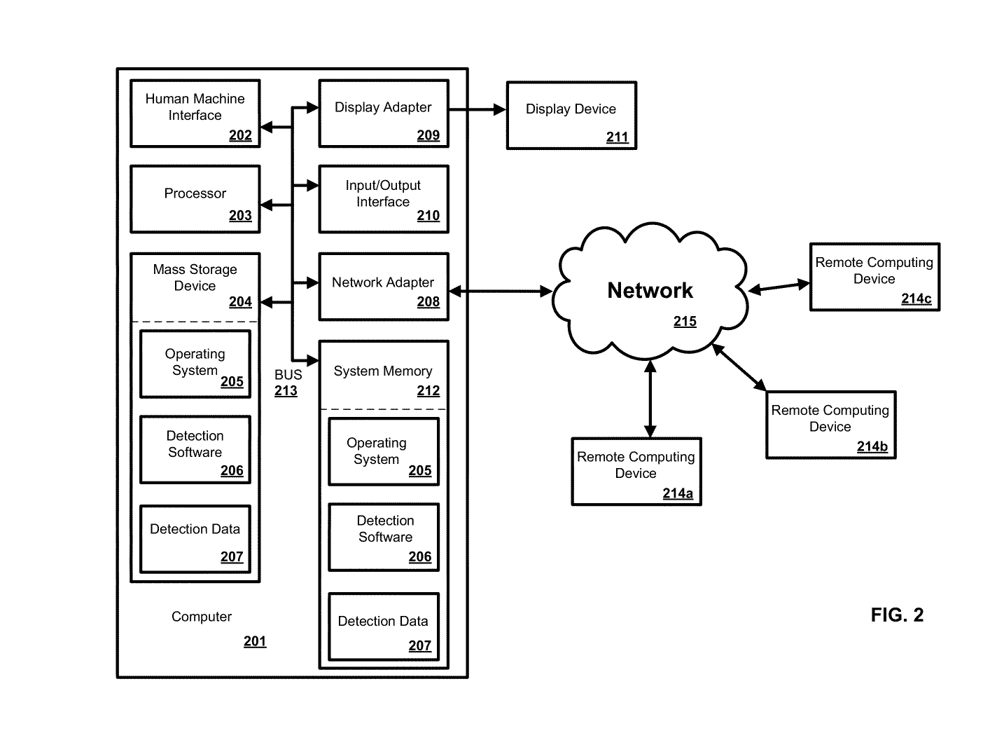

In an exemplary aspect, the methods and systems can be implemented on a computing system such as computing device 201 as illustrated in FIG. 2 and described below. By way of example, one or more of the seller device 102, the computing device 104, and the user device 124 of FIG. 1 can be a computer as illustrated in FIG. 2. Similarly, the methods and systems disclosed can utilize one or more computers to perform one or more functions in one or more locations. FIG. 2 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

FIG. 2 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 201. The components of the computer 201 can comprise, but are not limited to, one or more processors or processing units 203, a system memory 212, and a system bus 213 that couples various system components including the processor 203 to the system memory 212. In the case of multiple processing units 203, the system can utilize parallel computing.

The system bus 213 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 213, and all buses specified in this description can also be implemented over a wired or wireless network connection and each of the subsystems, including the processor 203, a mass storage device 204, an operating system 205, advertising software 206, advertising data 207, a network adapter 208, system memory 212, an Input/Output Interface 210, a display adapter 209, a display device 211, and a human machine interface 202, can be contained within one or more remote computing devices 214a,b,c at physically separate locations, connected through buses of this form, in effect implementing a fully distributed system.

The computer 201 typically comprises a variety of computer readable media. Exemplary readable media can be any available media that is accessible by the computer 201 and comprises, for example and not meant to be limiting, both volatile and non-volatile media, removable and non-removable media. The system memory 212 comprises computer readable media in the form of volatile memory, such as random access memory (RAM), and/or non-volatile memory, such as read only memory (ROM). The system memory 212 typically contains data such as financial data 207 and/or program modules such as operating system 205 and financial software 206 that are immediately accessible to and/or are presently operated on by the processing unit 203.

In another aspect, the computer 201 can also comprise other removable/non-removable, volatile/non-volatile computer storage media. By way of example, FIG. 2 illustrates a mass storage device 204 which can provide non-volatile storage of computer code, computer readable instructions, data structures, program modules, and other data for the computer 201. For example and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and advertising software 206. Each of the operating system 205 and advertising software 206 (or some combination thereof) can comprise elements of the programming and the advertising software 206. Advertising data 207 can also be stored on the mass storage device 104. Advertising data 207 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 201 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 203 via a human machine interface 202 that is coupled to the system bus 213, but can be connected by other interface and bus structures, such as a parallel port, game port, an IEEE 1394 Port (also known as a Firewire port), a serial port, or a universal serial bus (USB).

In yet another aspect, a display device 211 can also be connected to the system bus 213 via an interface, such as a display adapter 209. It is contemplated that the computer 201 can have more than one display adapter 209 and the computer 201 can have more than one display device 211. For example, a display device can be a monitor, an LCD (Liquid Crystal Display), or a projector. In addition to the display device 211, other output peripheral devices can comprise components such as speakers (not shown) and a printer (not shown) which can be connected to the computer 201 via Input/Output Interface 210. Any step and/or result of the methods can be output in any form to an output device. Such output can be any form of visual representation, including, but not limited to, textual, graphical, animation, audio, tactile, and the like.

The computer 201 can operate in a networked environment using logical connections to one or more remote computing devices 214a,b,c. By way of example, a remote computing device can be a personal computer, portable computer, a server, a router, a network computer, a peer device or other common network node, and so on. Logical connections between the computer 201 and a remote computing device 214a,b,c can be made via a local area network (LAN) and a general wide area network (WAN). Such network connections can be through a network adapter 208. A network adapter 208 can be implemented in both wired and wireless environments. Such networking environments are conventional and commonplace in offices, enterprise-wide computer networks, intranets, and the Internet 215.

For purposes of illustration, application programs and other executable program components such as the operating system 205 are illustrated herein as discrete blocks, although it is recognized that such programs and components reside at various times in different storage components of the computing device 201, and are executed by the data processor(s) of the computer. An implementation of advertising software 206 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” ‘Computer storage media’ comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

As described in greater detail below, provided are methods for issuing a virtual financial instrument such as a virtual prepaid card, wherein the virtual prepaid card can be used at a point of sale to accomplish a financial transaction such as making a purchase.

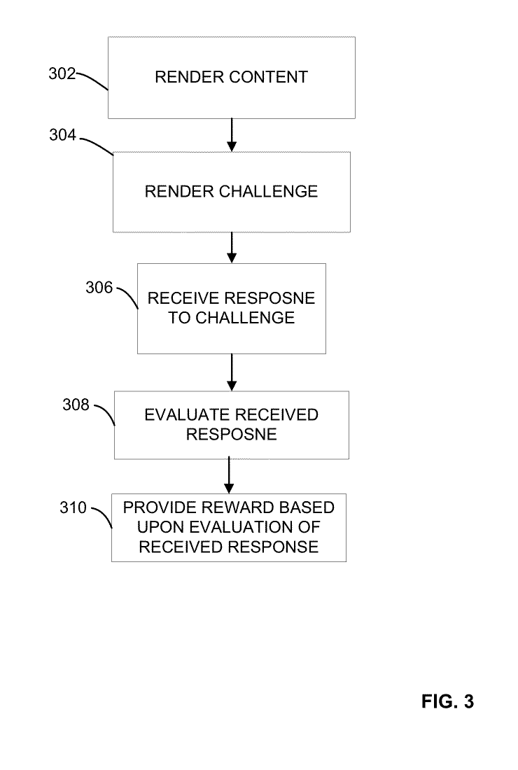

In an aspect, FIG. 3 illustrates an exemplary method for generating and/or rendering an advertisement. The method illustrated in FIG. 3 will be discussed in reference to FIGS. 1-2. In step 302, content is rendered to one or more users. In an aspect, the computing device 104 renders/transmits a content to the user device 124 such that a user can consume (e.g., view, listen, interact, etc.) with the rendered content. As an example, the content can comprise images, audio, and or video. As a further example, the content can be contextually related to a particular product or service provided by a merchant.

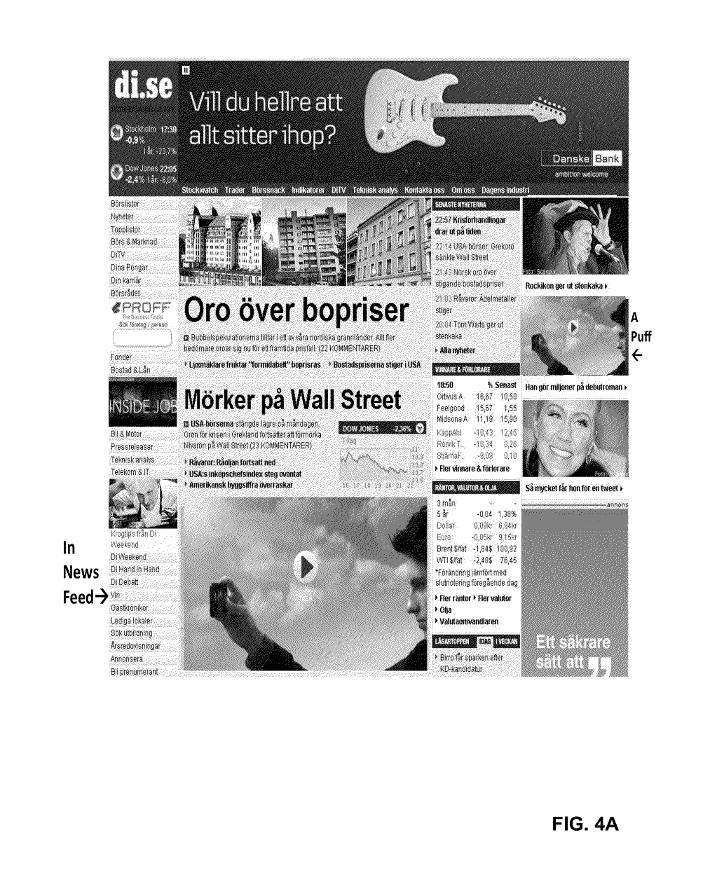

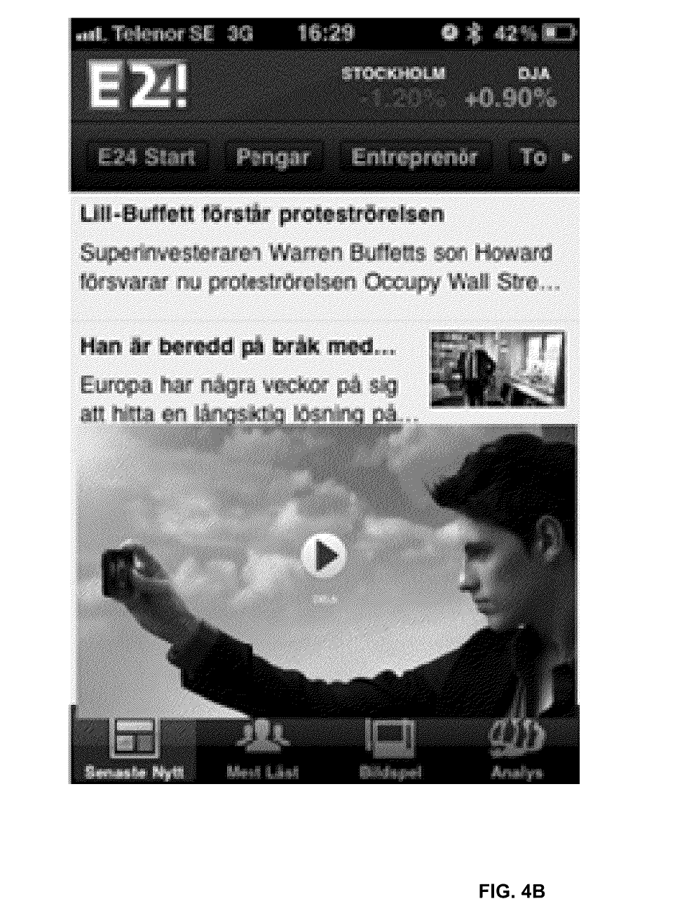

In an aspect, the content can be rendered via a hardware and/or software content player, such as illustrated in FIG. 4A. As an example, the content player can be an expandable player responsive to a particular banner or advertisement. As a further example, the advertisement/banner can comprise a countdown function starting a countdown when an icon is scrolled over the banner (e.g., mouse over). The banner can also comprise overlays and can play a shortened version of the content video as a thumbnail. As an example, when the banner is engaged (e.g., clicked) or the countdown has ended, the player initiates playback. As a further example, the player can be a widget comprising an application (e.g. a mobile app such as shown in FIG. 4B) that can be transferred to a social media site and be tracked around the internet. The person/computer transferring the player can be identified and a share reward can be selectively provided.

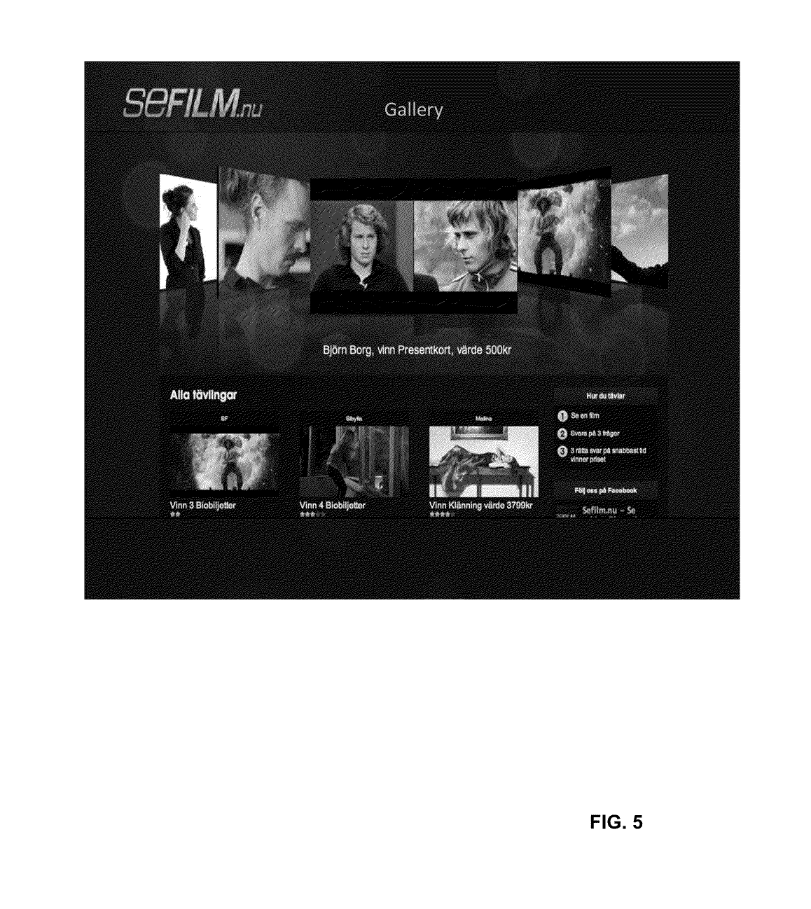

In an aspect, the content is rendered in a gallery, such as illustrated in FIG. 5. As a non-limiting example, the gallery can be an independent front end connected to the player/banner so that the viewer has the opportunity to see more content/advertisements in a finite screen space. As an example, the gallery can comprise a plurality of advertisements (e.g., video content, thumbnails, etc.) from any number of advertisers. As a further example, one or more of the advertisements can be categorized/classified by type, content, product, genre or the like. Rewards/prizes can be associated with particular categories of advertisements. In an aspect, certain “golden opportunities” can be identified, wherein a special reward or credit can be earned.

Returning to FIG. 3, in step 304, a challenge is rendered to the one or more users. In an aspect, the computing device 104 renders/transmits a challenge to the user device 124 such that a user can consume (e.g., view, listen, interact, etc.) with the rendered content. As an example, the challenge can comprise one or more questions, games, and/or interactive applications to engage the user/viewer. As a further example, the challenge is contextually related to the content rendered to the user.

In step 306, a response to the challenge is received. In an aspect, the computing device 124 receives a response to the challenge. In step 308, the received response is evaluated. As an example, the received response can be compared to a comparator element.

In step 310, a reward can be provided based upon the comparison of the received response and the comparator element. As an example, the reward can be a virtual credit or coupon for use at the point of sale 108. As a further example, the reward can be digitalized together with the supplier to become a QR code, Barcode, unique alpha-numeric code or similar that is used in the relevant country or region.

In an aspect, when a winning user is identified, the user can receive an e-mail, electronic token, or some identifier along with a log-in to the secure winner section of the platform or the point of sale 108. As an example, when the prize is a digital prize a “prize button” can be shown and a secure code is provided to the user. As a further example, the secure code can be used to redeem the reward (e.g., in cooperation with a unique locator or SIM card authentication).

In an aspect, a quotation system can be defined for estimating and optimizing the total cost of placements, prizes for winners, prize for sharers, sent out coupons/rewards and used coupons/rewards. As an example, defining a target group with an advertiser can comprise reviewing a number of placements at various publishers. In an aspect, each publisher has its own Reach (R) including Share of Voice (SoV) and CPM (e.g., cost per thousand or other number). A mix of advertisers can represent a weighted average CPM (X) and Reach (R).

As an example, every visitor to a site sees a video loop as it runs in the banner. The number of actively viewed video ads are those that click on the ad. As an example, of the number that click the ad, a certain rate (Q) will answer the quiz/challenge. As a further example, of the number that answer the challenge, a certain rate (R) will register their name and of these a certain rate (S) will accept and opt-in other promotions. In an aspect, if there is a coupon offer provided, only a certain rate (T) will accept the coupon. In certain aspects, there is an admin cost per coupon (L). Additionally there can be a fixed cost for coupons and a fixed cost for administrating the promotion. As an example, V=#incoming viral viewers, (as an example, the numbers will be something like Variable*(Sharing price(SEK)/100)̂½*0.5%*fb-friends) and U=#incoming viral gamers=V*B % (some percentage factor of viewers that interact with the challenge). In an aspect, the rates/variables P, Q, R, S, T, U, B, are probability factors based on experience factors that are update (e.g., periodically, continuously).

As discussed herein, cost factors H, I, J, K, L can be configurable depending on the market situation.

R=Viewed loops (weigthedaverage−placements&cost), wherein

Cost=R*X/1000

A=#Actively viewed video-ads=R*P %+V, H=cost per view, wherein

Cost=A*H,

G=#Gamers+viral Gamers=A*Q %+U; I=cost per gamer, wherein,

Cost=G*I

N=# Register theirname=G*R %; J=cost per registered gamer, wherein,

Cost=N*J

F=#Accepting other promotions=N*S %; K=cost per opt-in for promo,

wherein Cost=F*K

C=#Getting the Coupon=N*T %; L=cost for the coupon registration,

wherein Cost=C*L

Cost for advertising can be the sum cost or subtotal cost of one or more of the above costs functions. As an example, a start fee coupon (clearance and mobile) can be added to the sum cost and a start fee Sefilm or Start fee Advertising can be added to the sum cost to result in a Total Offer. In an aspect, S=#Viral sharers (e.g. G*(Sharing Prize(SEK)/50)̂0.5/100)).

In an aspect, advertisements, challenges, and/or rewards can be adapted based upon a particular user or location such as a region or country. For example, a global campaign for a global product can comprise local languages for the challenge, localized prizes for winners and sharers as well as a localized coupon system for rewarding those that contested and interacted with the advertiser. As a further example, global advertiser can launch a new campaign in several countries with different languages at the same time. The provisioning is done by country/language. In an aspect, each country has one or more defined languages, which are defined by regions and by the IP addresses in the database 114 or other storage medium. For each language the relevant challenges (e.g., questions and answers) are supplied to the challenge and stored in a language Q&A database. In an aspect, an IP address of the viewer can be determined and present the language based on the regional language stores in the language Q&A database. Thus, a user in Geneva can receive French language questions based on the IP address in Geneva. As an example, rewards/prizes can be processed in a similar way to be regionalized, since each country may be using a local digital coupon system which may be used to distribute the prizes and rewards and coupons, in local retail chains.

In an aspect, one or more of the advertisements can comprise a click-to-call icon and/or a “call for free” button, whereby, upon engagement, a call to buy function can be presented to a viewer enabling a “shop” function associated with the advertisement. As an example, particular products or advertisers can be highlighted or organized in more favorable viewing positions within a viewable window. As a further example, the gallery can comprise a graphical overlay or skin. As a further example, the skins can be brand specific, language specific, and/or otherwise themed.

In an aspect, the challenge can be initiated from a QR code. In a campaign, the advertiser may render a QR code via a display screen, a digital shelf label, or on a product package. By scanning the QR code, the user is directed to a URL-ID of a campaign and the content/advertisement is rendered. As an example, the viewer can view the advertisement and be part of the challenge or the sampling before or after the challenge.

In an aspect, a “sharing button” can be rendered with the content/advertisement. As an example, the sharer of the advertisement can be identified and the recipient(s) are tracked so that if a recipient wins also the sharer wins. As an example, the reward is configurable to any reward value. In an aspect, one or more reward levels can be defined for sharing the content. As an example, one level can be a general sharing prize, while another level can be a prime sharing prize for particular recipients. As a further example, the rewards/prizes and sharing levels can be time limited.

In an aspect, interactions (e.g., click tracking, eye tracking, and the like) and/or rewards can be tracked in order to provide feedback relating to at least the activation and use of the rewards. As an example, a merchant/advertiser can launch a promotion. As a further example, a plurality of users are identified by user identification information provided to the computing device 104. However, any user can participate in the promotion. The computing device 104 can process the user identification information and other tracked information to log information about the user and the promotion. In this way, the merchant can manage specific promotions based upon user response and interaction.

In an aspect, information relating to advertiser records, virtual rewards issued to customers, and notifications, can be managed, viewed, and/or monitored. As an example, the computing device 104 can store such information and can be accessed by a user, merchant, or other authorized or designated device, person, or entity. As a further example, the computing device 104 can provide analysis of the information stored thereon such as usage tracking/monitoring/logging, generating statistics useful for advertising, generating statistic based upon reward activation and/or usage such as spending patterns based on location or other demographic information, generating feedback reports relating to advertisement and/or promotional campaigns (e.g., to evaluate success of a particular campaign). Other devices and/or systems can be configured to store and/or analyze information relating to sellers, users, card holders, recipients of notifications, and points of sale, for example. Various analysis techniques can also be used and various results can be generated.

In an aspect, a fraud tracking feature can comprise analysis of an interaction with an advertisement and/or challenge. As an example, certain users can be blacklisted based on abnormal pattern recognition or interactions with the challenge or advertisement that match a pre-defined pattern list. Any number of users can be filtered or pre-approved for interaction with a given advertisement.

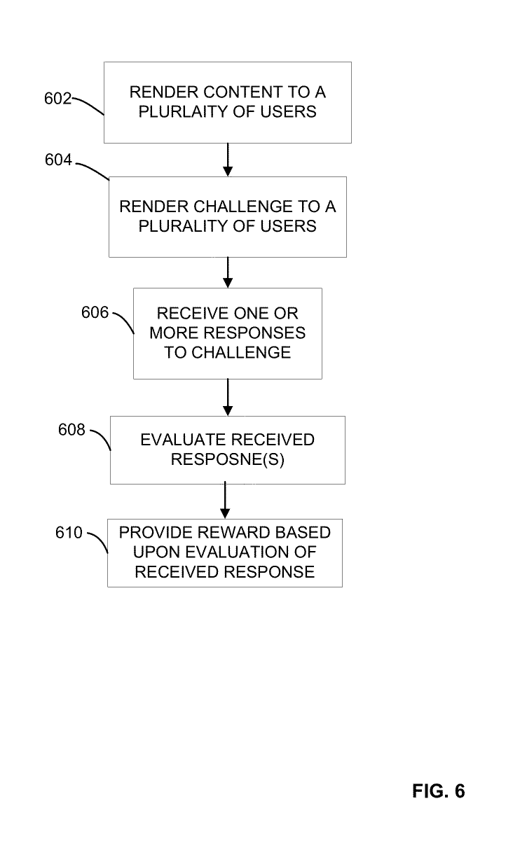

As described in greater detail below, provided are methods for accessing, using, and managing a advertisements and related challenges. In an aspect, FIG. 6 illustrates an exemplary method for using a financial instrument. The method illustrated in FIG. 6 will be discussed in reference to FIGS. 1-5.

In an aspect, in step 602, content is rendered to a plurality of users. In an aspect, the computing device 104 renders/transmits a content to plurality of the user devices 124 such that a plurality of users can consume (e.g., view, listen, interact, etc.) with the rendered content. As an example, the content can comprise images, audio, and or video. As a further example, the content can be contextually related to a particular product or service provided by a merchant.

In step 604, a challenge is rendered to the one or more users. In an aspect, the computing device 104 renders/transmits a challenge to the user device 124 such that a user can consume (e.g., view, listen, interact, etc.) with the rendered content. As an example, the challenge can comprise one or more questions, games, and/or interactive applications to engage the user/viewer. As a further example, the challenge is contextually related to the content rendered to the user.

In step 606, one or more responses can be received. As an example, each response comprises a time element defined by a time between the rendering of the challenge and the receipt of the respective response. As a further example, the computing device 104 receives the one or more response (e.g., including the time element).

In step 608, the received response(s) can be evaluated. As an example, the computing device 104 can compare the received response to a comparator element to define one or more correct response. As a further example, one of the correct responses can be selected based upon a comparison of the respective time elements.

In step 610, a reward can be provided based upon the comparison of the received response and the comparator element. As an example, the reward can be a virtual credit or coupon for use at the point of sale 108. As a further example, the reward can be digitalized together with the supplier to become a QR code, Barcode, unique alpha-numeric code or similar that is used in the relevant country or region providing a reward to the user associated with the selected correct response.

In an aspect, two or more users can challenge each other by invitation (e.g., social network, e-mail, or other correspondence). As an example, after one person press a “buddy challenge button” or otherwise initiates a challenge and directs the challenge over email or social media to another user (e.g., buddy or a number of buddies). In an aspect, the computing device 104 can select one or more challenges to be rendered to users during and/or after the advertisement. As an example, the users can compete within a pre-defined time limit. Each of the users can participate in a tournament style challenge. As an example, the winner of the tournament is granted a reward. As a further example, the reward can be based upon the number of users participating the tournament. In an aspect, a double challenge can comprise inviting a friend on social media or other via the system. In response to the invitation, the invited friend can accept to view and compete via the system. Accordingly, the system configure the prize based upon a number of invited friends participating or accepting invitations. The inviter can also be rewarded based upon the number of invites and the number of respondents.

In an aspect, a plurality of users can be grouped as a team for a challenge. As an example, a group or team of users can participate against another group or team of users. As a further example, the group members can work in parallel to provide an answer/response to the challenge. As a further example, each of the group members can participate in concert, wherein each of the group members must provide a correct response in order for the team to be awarded the reward.

In an aspect, one or more select users (e.g., winners) can be invited to a competition placed on the home page or social media page of the advertiser. As an example, the “winners competition” can provide increasing worth of rewards and can be configured to result is a final competition with a grand prize. In this way, the advertisement exposure to the merchant/advertiser is maximized. In an aspect, one or more advertisers can also compete with each other, wherein the advertiser logging the most interaction on a particular promotion can be awarded content space for further advertisements.

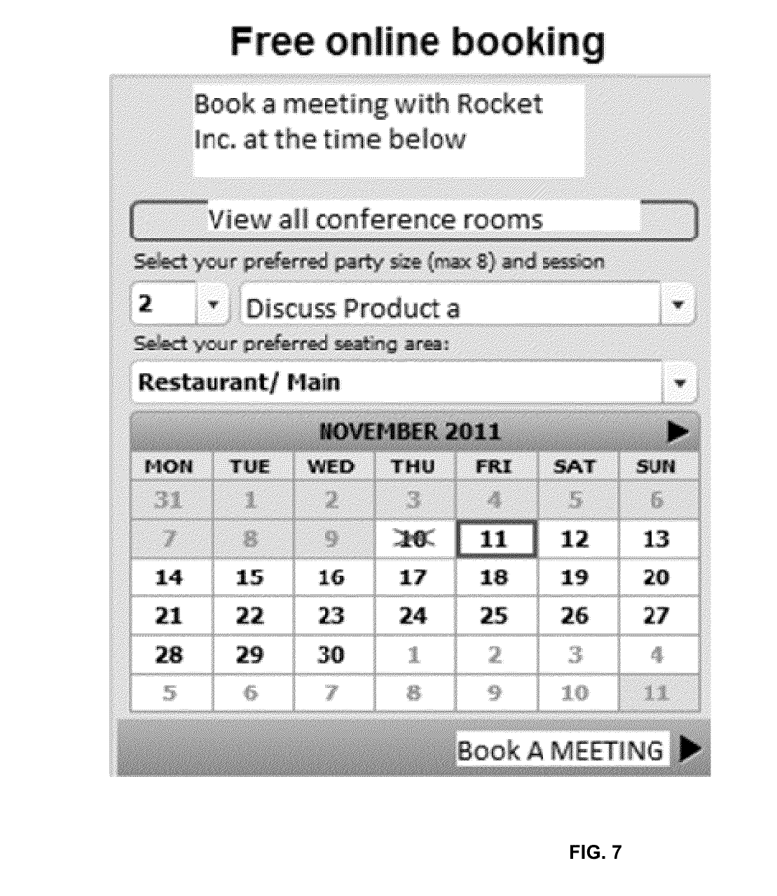

In an aspect, a scheduling system or booking system for conferences and trade shows (e.g., for 1:1 meetings at the event), as illustrated in FIG. 7. As an example, the scheduling system can be comprised as at least a portion of the front end at a conference host web page or a trade fair web page. As an example, a user can view content and participate in a challenge. Before, during or after the content rendering a user can schedule a meeting with a merchant/advertiser. A confirmation can be transmitted to the user and the schedule merchant.

The advantages for the advertisers are several and include: low cost for complete campaigns, providing a one stop to market and promote a product; activating a region or a target group; enhance or complement the message in the video-ad; targeted challenges based on user and/or location; responses become a basis for a market survey about the product and company; a viewer is actively interacting with the advertiser's questions; a viewer may have to visit the website to be able to respond; the prize category is a way to target a specific group to watch the video; the respondent provides their email so they can be contacted if they win; Digital POS/TV ads can use the same concept for efficiency in Marketing Sales promotions.

The systems and methods can comprise a reward system, where the advertiser can set the level of the reward for the “sharing person” and/or a “challenge your friends” concept, where friends compete against each other.

With online/offline Video-ad challenges connected to digital POS activities the Marketing awareness schedule can rule as the digital screens can use the same message and the coupon system can be programmed in line with shelf push from the internet via mobile coupons.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
rendering content;
rendering a challenge, wherein the challenge is contextually related to the content;
receiving a response to the challenge;
comparing the received response to a comparator element; and
providing a reward based upon the comparison of the received response and the comparator element.

2. The method of claim 1, wherein the challenge is rendered simultaneously with the content.

3. The method of claim 1, wherein the content comprises one or more of a visual component and an audio component.

4. The method of claim 1, wherein the content comprises one or more videos.

5. The method of claim 1, wherein the content is rendered for a duration of about between 5 and 50 seconds.

6. The method of claim 1, wherein the content is rendered in a first time sequence and further comprising rendering the content is a second time sequence in order to determine and evaluate any discrepancies in responses received based upon the rendered challenge.

7. The method of claim 1, wherein the challenge comprises a question.

8. The method of claim 1, wherein the response can only be received within a predetermined time from the rendering of the challenge.

9. A method comprising:
rendering content to a plurality of users;
rendering a challenge to the plurality of users, wherein the challenge is contextually related to the content;
receiving one or more responses to the challenge, wherein each response comprises a time element defined by a time between the rendering of the challenge and the receipt of the respective response;
comparing the received response to a comparator element to define one or more correct response;
selecting one of the correct responses based upon a comparison of the respective time elements; and
providing a reward to the user associated with the selected correct response.

10. The method of claim 9, wherein the challenge is rendered simultaneously with the content.

11. The method of claim 9, wherein the content comprises one or more of a visual component and an audio component.

12. The method of claim 9, wherein the content comprises one or more videos.

13. The method of claim 9, wherein the content is rendered for a duration of about between 5 and 50 seconds.

14. The method of claim 9, wherein the content is rendered in a first time sequence and further comprising rendering the content is a second time sequence in order to determine and evaluate any discrepancies in responses received based upon the rendered challenge.

15. The method of claim 9, wherein the challenge comprises a question.

16. The method of claim 9, wherein the response can only be received within a predetermined time from the rendering of the challenge.

17. The method of claim 9, wherein each of the received responses comprises a user information associated with the respective user.

18. The method of claim 17, wherein the user information includes one or more of a user identifier and a demographic information relating to the respective user.

19. A method comprising:
rendering content to a first user for a duration of about between 5 and 50 seconds;
rendering a share option to the first user;
receiving a selection of the share option;
rendering the content to a second user in response to receiving the selection of the share option; and
providing a reward to the first user based upon the selection of the share option.

20. A system comprising:
a memory for storing challenge data; and
a processor in communication with the memory, the processor configured to:
transmit content;
transmit a challenge based upon the challenge data, wherein the challenge is contextually related to the content;
receive a response to the challenge;
compare the received response to a comparator element; and
provide a reward based upon the comparison of the received response and the comparator element.

21. The system of claim 20, wherein the challenge is transmitted simultaneously with the content.

22. The system of claim 20, wherein the content comprises one or more videos.

23. The system of claim 20, wherein the content is rendered for a duration of about between 5 and 50 seconds.
